(19) United States
(12) Patent Application Publication
(10) Pub. No.: US 2026/0055868 A1
(43) Pub. Date: Feb. 26, 2026

(54) VEHICLE LAMP

(71) Applicant: Stanley Electric Co., Ltd., Tokyo (JP)

(72) Inventor: Koji SATO, Tokyo (JP)

(21) Appl. No.: 19/104,914

(22) PCT Filed: Aug. 3, 2023
(86) PCT No.: PCT/JP2023/028432

§ 371 Date: Feb. 19, 2025

(30) Foreign Application Priority Data
Aug. 23, 2022 (JP) 2022-132234

(51) Int. Cl. F21S 43/241; F21S 43/14; F21S 43/235; F21S 43/237; F21S 43/242; F21S 43/245; F21Y 115/10

(52) U.S. Cl. CPC F21S 43/241; F21S 43/14; F21S 43/237; F21S 43/245; F21S 43/246; F21S 43/252; F21Y 2115/10

(57) ABSTRACT

A light guide body has first protrusion protruding from first curved portion toward a side opposite to diverging portion, second protrusion protruding from second curved portion toward a side opposite to the diverging portion, optical axis of light emitted from light source is arranged to be shifted to the one side or the other side in first direction with respect to a boundary of the diverging portion, and according to proportion of lights diverged to the side of a second light guide part and the side of a third light guide part via the diverging portion, a position of a first connecting portion, to which the first protrusion and the first curved portion are connected, is different from a position of a second connecting portion, to which the second protrusion and the second curved portion are connected, in a second direction which is perpendicular to at least the first direction.

This application is a U.S. National Stage Application under 35 U.S.C § 371 of International Patent Application No. PCT/JP2023/028432 filed Aug. 3, 2023, which claims the benefit of priority under 35 U.S.C. § 119 to Japanese Patent Application No. 2022-132234 filed Aug. 23, 2022, the disclosures of all of which are hereby incorporated by reference in their entireties.

### TECHNICAL FIELD

The present invention relates to a vehicle lamp.

### BACKGROUND ART

In the related art, a known configuration of a vehicle lamp installed in a vehicle is a combination of a light source such as a light emitting diode (LED) and a rod-shaped or plate-shaped light guide body.

In such a vehicle lamp, light emitted from the light source enters the base end side of the light guide body, and is guided toward the tip side of the light guide body while the light is repeatedly reflected inside the light guide body. In addition, the light reflected by a plurality of reflection cuts provided on the back surface side of the light guide body is emitted from the front surface side of the light guide body. Accordingly, a light emitting section provided on a front surface side of the light guide body can emit light in a line shape or a planar shape.

In addition, some vehicle lamps have a configuration in which light is diverged through a diverging portion provided in a light guide body, and then, a light emitting section provided between one side and the other side of the light guide body that sandwich the diverging portion emits light (for example, see the following Patent Document 1).

### CITATION LIST

### Patent Document

Patent Document 1: Japanese Unexamined Patent Application, First Publication No. 2017-92011

### SUMMARY OF INVENTION

### Technical Problem

Incidentally, in the above-mentioned light guide body, differences in an optical path length of the light guided from the base end side to the tip side could result in brightness unevenness in the light emitting section. That is, when the brightness unevenness occurs in the light emitting section of the light guide body, in the axial direction of the light guide body, the tip side, which has a longer optical path length from the light source, becomes relatively darker due to light attenuation than the base end side, which has a shorter optical path length from the light source. Accordingly, such variation in brightness is perceived as uneven brightness in the light emitting section.

For this reason, when the rod-shaped light guide body emits light in a line shape, the occurrence of the brightness unevenness mentioned above has led to problems such as deterioration of lighting feeling, such as deterioration in visibility and appearance of the light emitting section.

In addition, when a partially curved portion or a diverging portion of the light guide body is provided between the incidence section and the light emitting section, if the length of the curved portion or the diverging portion is short and the curvature is small, some of the light guided inside the curved portion or the diverging portion is not directed towards the tip side of the light guide body, and leaks out from the curved portion or the diverging portion as stray light. In this case, a part of the base end side of the curved portion or the diverging portion appears to shine brighter than the surrounding areas, creating a so-called point light, which causes deterioration in the appearance of the vehicle lamp when it is lit.

Further, even if a rib portion is provided to connect one light guide part and the other light guide part between which the diverging portion is interposed, and the rib portion is made to emit light, the appearance upon emission will be poor due to the brightness unevenness that occurs in the rib portion. In particular, when the optical axis of the light emitted from the light source is disposed to be shifted from the boundary of the diverging portion, differences in the light quantity of the light diverged in the diverging portion occur, and thus, brightness unevenness becomes more noticeable.

An aspect of the present invention is directed to providing a vehicle lamp capable of improving appearance upon emission by preventing occurrence of brightness unevenness.

### Solution to Problem

An aspect of the present invention provides the following configurations.
(1) A vehicle lamp including:
   a light source; and
   a light guide body configured to guide light emitted from the light source,
wherein the light guide body has:
   a first light guide part disposed in front of the light source;
   an incidence section that is located on a base end side of the first light guide part and that is configured to cause the light emitted from the light source to enter the first light guide part;
   a diverging portion located on a tip side of the first light guide part;
   a second light guide part extending from the diverging portion toward one side in a first direction;
   a third light guide part extending from the diverging portion toward the other side in the first direction;
   a first curved portion that is a portion of the second light guide part curved from the diverging portion toward the one side in the first direction;
   a second curved portion that is a portion of the third light guide part curved from the diverging portion toward the other side in the first direction;
   a first protrusion protruding from the first curved portion toward a side opposite to the diverging portion; and
   a second protrusion protruding from the second curved portion toward a side opposite to the diverging portion,
   an optical axis of the light emitted from the light source is arranged to be shifted to the one side or the other side in the first direction with respect to a boundary of the diverging portion, and
   according to a proportion of the light diverged to the side of the second light guide part and the side of the third light guide part via the diverging portion,
   a position of a first connecting portion, at which the first protrusion and the first curved portion are connected, is different from a position of a second connecting portion, at which the second protrusion and the second curved portion are connected, in a second direction which is perpendicular to at least the first direction.
(2) The vehicle lamp according to the above-mentioned (1), wherein the first connecting portion and the second connecting portion are; disposed closer to a center axis of the first curved portion and the second curved portion in the second direction as a proportion of the light diverged via the diverging portion gets relatively reduced, and
   disposed to be more shifted from the center axis of the first curved portion and the second curved portion in the second direction as the proportion of the light diverged via the diverging portion gets relatively increased.
(3) The vehicle lamp according to the above-mentioned (1), wherein, according to the proportion of the light diverged to the side of the second light guide part and the side of the third light guide part via the diverging portion,
   cross-sectional areas of the first connecting portion and the second connecting portion are different from each other.
(4) The vehicle lamp according to the above-mentioned (3), wherein the cross-sectional areas of the first connecting portion and the second connecting portion are relatively reduced as the proportion of the light diverged via the diverging portion is relatively increased, and
   the cross-sectional areas of the first connecting portion and the second connecting portion are relatively increased as the proportion of the light diverged via the diverging portion is relatively reduced.
(5) The vehicle lamp according to the above-mentioned (1), wherein the light guide body has:
   a first reflecting section that is located on a back surface side of the second light guide part and that is configured to reflect the light guided in the second light guide part toward a front surface side of the second light guide part;
   a first emitting section that is located on a front surface side of the second light guide part and that is configured to emit the light reflected by the first reflecting section to an outside of the second light guide part;
   a second reflecting section that is located on a back surface side of the third light guide part and that is configured to reflect the light guided in the third light guide part toward a front surface side of the third light guide part;
   a second emitting section that is located on a front surface side of the third light guide part and that is configured to emit the light reflected by the second reflecting section to an outside of the third light guide part;
   a third reflecting section that is located on a back surface side of the first protrusion and that is configured to reflect the light guided in the first protrusion toward a front surface side of the first protrusion;
   a third emitting section that is located on a front surface side of the first protrusion and that is configured to emit the light reflected by the third reflecting section to an outside of the first protrusion;
   a fourth reflecting section that is located on a back surface side of the second protrusion and that is configured to reflect the light guided in the second protrusion toward a front surface side of the second protrusion; and
   a fourth emitting section that is located on a front surface side of the second protrusion and that is configured to emit the light reflected by the fourth reflecting section to an outside of the second protrusion.

### Advantageous Effects of Invention

As described above, according to the aspect of the present invention, it is possible to provide a vehicle lamp capable of improving appearance upon emission by preventing occurrence of brightness unevenness.

### BRIEF DESCRIPTION OF DRAWINGS

FIG. 1 A front view showing a configuration of a vehicle lamp according to an embodiment of the present invention.

FIG. 2 A bottom view showing the configuration of the vehicle lamp shown in FIG. 1.

FIG. 3 A front view of the vehicle lamp, an enclosed portion III shown in FIG. 1 being enlarged.

FIG. 4 A bottom view of the vehicle lamp, an enclosed portion IV shown in FIG. 2 being enlarged.

FIG. 5 A cross-sectional view of the vehicle lamp along line segment V-V shown in FIG. 3.

FIG. 6 A cross-sectional view of the vehicle lamp along line segment VI-VI shown in FIG. 3.

FIG. 7 A cross-sectional view of the vehicle lamp along line segment VII-VII shown in FIG. 3.

FIG. 8 A cross-sectional view of the vehicle lamp along line segment VIII-VIII shown in FIG. 3.

FIG. 9 A front view showing a light source and a first inner lens shown in FIG. 3.

FIG. 10 A plan view of the first inner lens shown in FIG. 9.

FIG. 11 A cross-sectional view of the light source and the first inner lens along line segment XI-XI shown in FIG. 9.

FIG. 12 A cross-sectional view of the light source and the first inner lens along line segment XII-XII shown in FIG. 9.

### DESCRIPTION OF EMBODIMENTS

Hereinafter, an embodiment of the present invention will be described with reference to the accompanying drawings.

Further, in the drawings used in the following description, in order to make each component easier to see, dimensions of each component may be shown at different scales, and dimensional proportions of each component may not necessarily be the same as in reality.

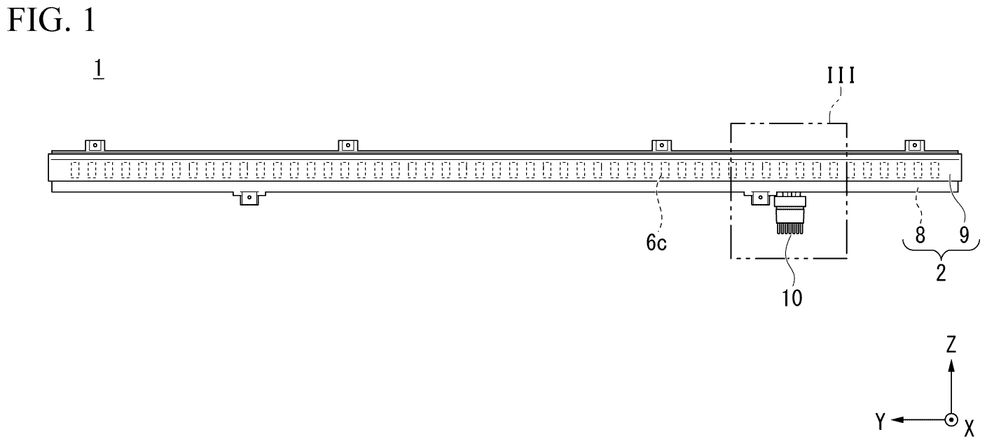

As the embodiment of the present invention, for example, a vehicle lamp 1 shown in FIG. 1 to FIG. 12 will be described.

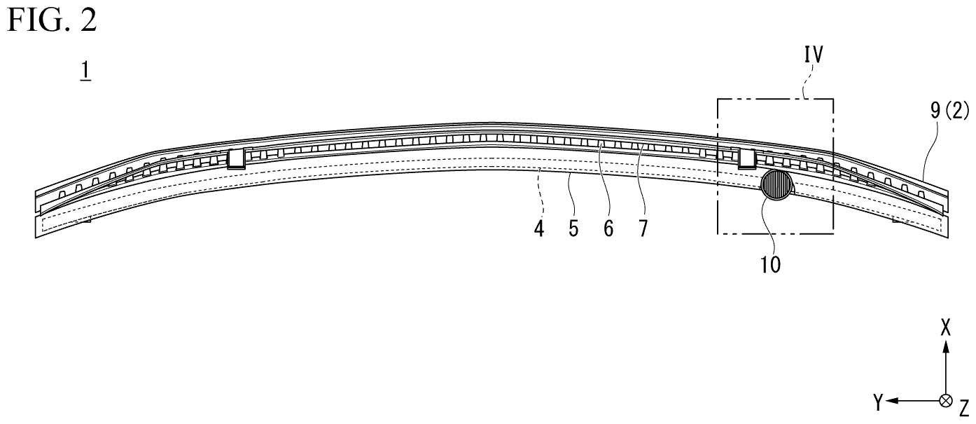

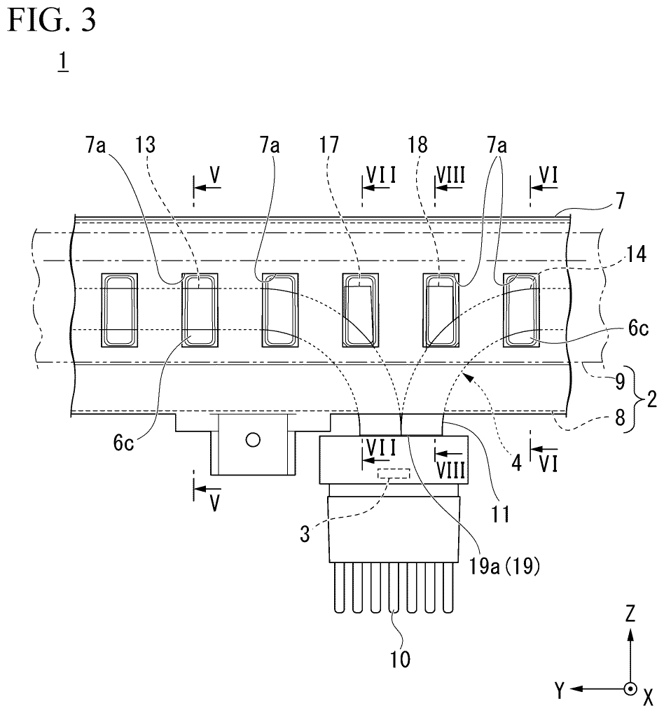

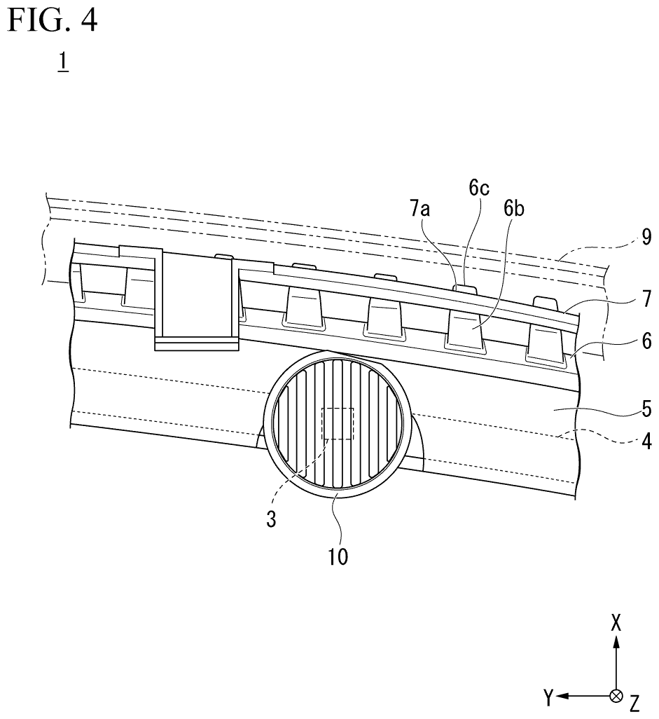

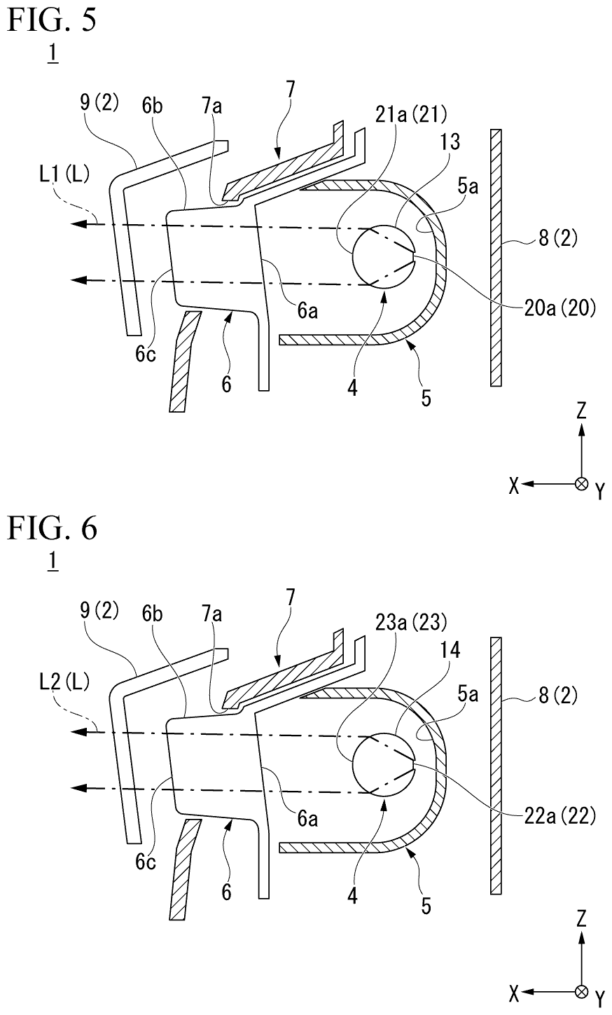

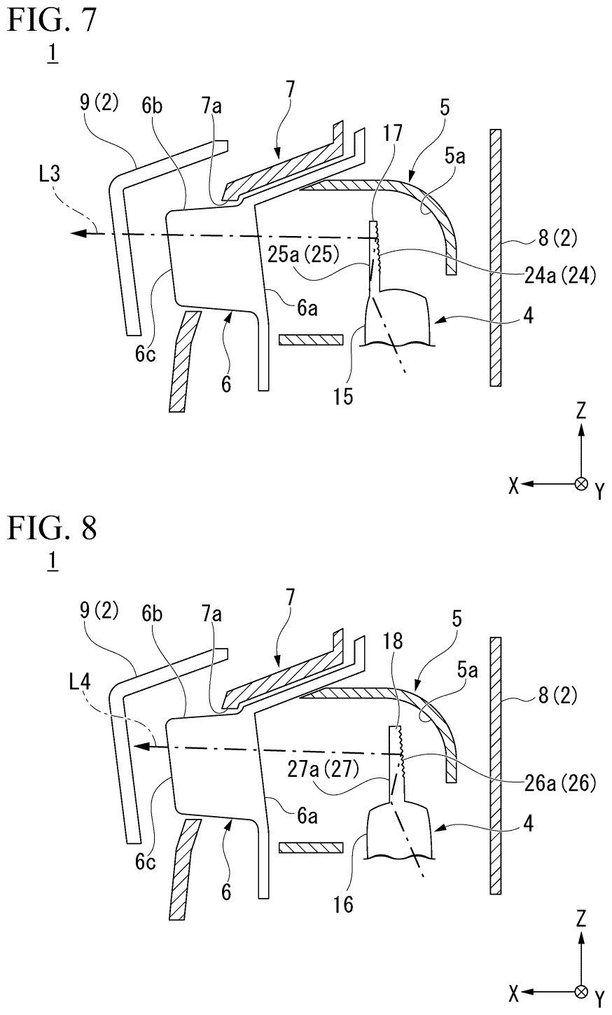

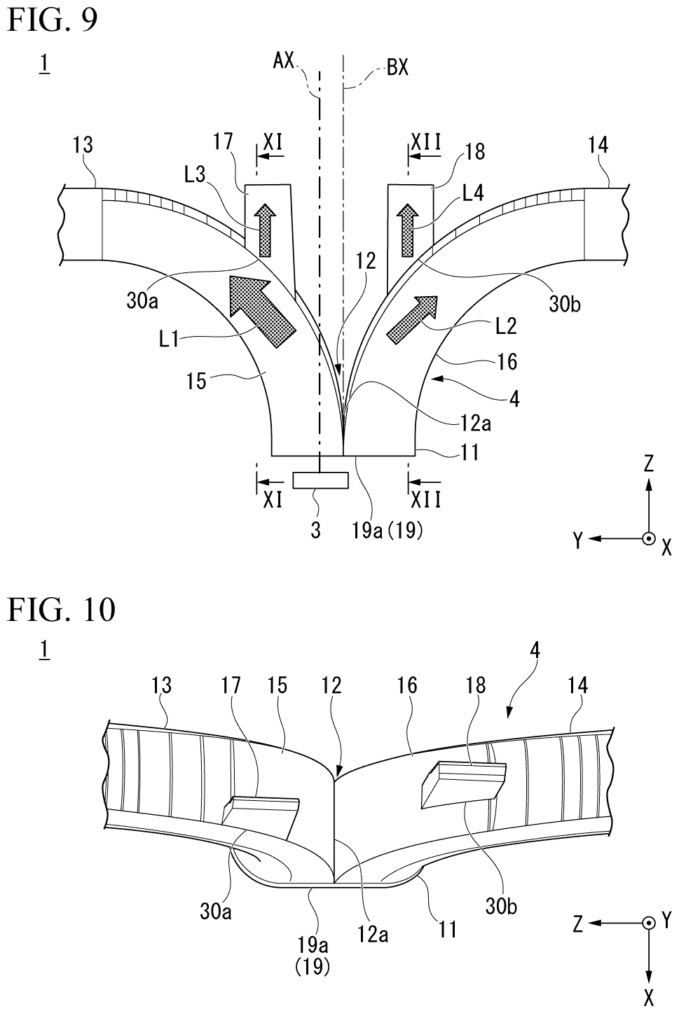

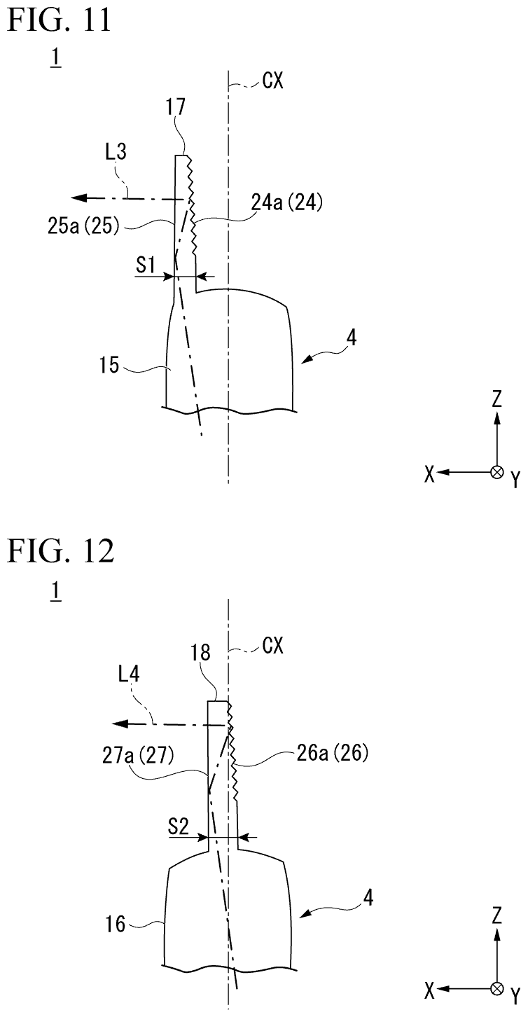

Further, FIG. 1 is a front view showing a configuration of the vehicle lamp 1. FIG. 2 is a bottom view showing a configuration of the vehicle lamp 1. FIG. 3 is a front view of the vehicle lamp 1, an enclosed portion III shown in FIG. 1 being enlarged. FIG. 4 is a bottom view of the vehicle lamp 1, an enclosed portion IV shown in FIG. 2 being enlarged. FIG. 5 is a cross-sectional view of the vehicle lamp 1 along line segment V-V shown in FIG. 3. FIG. 6 is a cross-sectional view of the vehicle lamp 1 along line segment VI-VI shown in FIG. 3. FIG. 7 is a cross-sectional view of the vehicle lamp 1 along line segment VII-VII shown in FIG. 3. FIG. 8 is a cross-sectional view of the vehicle lamp 1 along line segment VIII-VIII shown in FIG. 3. FIG. 9 is a front view showing a light source 3 and a first inner lens 4 shown in FIG. 3. FIG. 10 is a plan view of the first inner lens 4 shown in FIG. 9. FIG. 11 is a cross-sectional view of the light source 3 and the first inner lens 4 along line segment XI-XI shown in FIG. 9. FIG. 12 is a cross-sectional view of the light source 3 and the first inner lens 4 along line segment XII-XII in FIG. 9.

In addition, in the drawings as described below, an XYZ orthogonal coordinate system is set, an X-axis direction indicates a forward/rearward direction (lengthwise direction) of the vehicle lamp 1, a Y-axis direction indicates a leftward/rightward direction (widthwise direction) of the vehicle lamp 1, and a Z-axis direction indicates an upward/downward direction (height direction) of the vehicle lamp 1.

The vehicle lamp 1 of the embodiment is, for example, an application of the present invention to a lid lamp mounted on a back gate or a trunk lid on a rear side of the vehicle.

Further, in the following description, description of directions of “forward,” “rearward,” “leftward,” “rightward,” “upward” and “downward” means directions when the vehicle lamp 1 is seen from a front surface (a side behind the vehicle) unless the context indicates otherwise. Accordingly, directions when the vehicle is seen from a front surface (a side in front of the vehicle) are directions in which the directions of forward, rearward, leftward and rightward are reversed.

As shown in FIG. 1 to FIG. 9, the vehicle lamp 1 of the embodiment has a configuration in which the light source 3, the first inner lens 4, a reflector 5, a second inner lens 6, and an extension 7 are disposed inside a lighting body 2.

The lighting body 2 has a housing 8 with a front surface that is open and a transparent outer lens (cover lens) 9 configured to cover the opening of the housing 8, and has a long shape extending in a widthwise direction of the vehicle (hereinafter, referred to as “a vehicle width direction”) as a whole.

In addition, the lighting body 2 has a curved shape from a center portion in the vehicle width direction toward both end portions in accordance with a slant shape given to both corner portions on the rear end side of the vehicle. Further, a shape of the lighting body 2 is not limited to this curved shape and can be changed as appropriate in accordance with the design of the vehicle, or the like.

The vehicle lamp 1 of the embodiment includes a coupler socket 10 in which the light source 3 is disposed. The coupler socket 10 is detachably attached to surroundings of an attachment hole (not shown) provided in a lower portion of the housing 8 while being inserted into the lighting body 2 from the attachment hole.

The light source 3 is constituted by at least one or a plurality of (in this embodiment, one) LEDs that emit red light (hereinafter, referred to as “light”) L, is mounted on a surface of a circuit board (not shown) on which a driving circuit that drives the LEDs is provided, and emits the light radially forward (upward in this embodiment).

Further, in the embodiment, while the configuration includes the coupler socket 10 in which the light source 3 is disposed, it is not necessarily limited to such a configuration, and the circuit board in which the light source 3 is disposed may be disposed inside the lighting body 2.

The first inner lens 4 is constituted by a light guide body made of a transparent resin such as polycarbonate or acryl, or glass, and is disposed in front of the light source 3 (the coupler socket 10).

The first inner lens 4 has a long round rod shape that extends asymmetrically in the vehicle width direction with respect to the light source 3 (the coupler socket 10) while matching with the shape of the lighting body 2. That is, the first inner lens 4 is arranged so that the light source 3 (the coupler socket 10) is disposed at a position which is shifted from the center portion in the vehicle width direction, and one side of the first inner lens 4 with respect to the light source 3 (the coupler socket 10) is longer than the other side.

The first inner lens 4 has a first light guide part 11 disposed in front of (in the embodiment, above) the light source 3, a diverging portion 12 located on a tip side (in the embodiment, an upper end side) of the first light guide part 11, a second light guide part 13 extending from the diverging portion 12 toward one side (in the embodiment, leftward) in the vehicle width direction, a third light guide part 14 extending from the diverging portion 12 toward the other side (in the embodiment, rightward) in the vehicle width direction, a first curved portion 15 that is a portion of the second light guide part 13 curved from the diverging portion 12 toward one side in the vehicle width direction, a second curved portion 16 that is a portion of the third light guide part 14 curved from the diverging portion 12 toward the other side in the vehicle width direction, a first protrusion 17 protruding from the first curved portion 15 toward a side opposite to the diverging portion 12, and a second protrusion 18 protruding from the second curved portion 16 toward a side opposite to the diverging portion 12.

In addition, the first inner lens 4 has an incidence section 19 located on a base end side (in the embodiment, a lower end side) of the first light guide part 11, a first reflecting section 20 located on a back surface side of the second light guide part 13 (in the embodiment, a back surface side of the vehicle lamp 1), a first emitting section 21 located on a front surface side of the second light guide part 13 (in the embodiment, a front surface side of the vehicle lamp 1), a second reflecting section 22 located on a back surface side of the third light guide part 14 (in the embodiment, a back surface side of the vehicle lamp 1), a second emitting section 23 located on a front surface side of the third light guide part 14 (in the embodiment, a front surface side of the vehicle lamp 1), a third reflecting section 24 located on a back surface side of the first protrusion 17 (in the embodiment, a back surface side of the vehicle lamp 1), a third emitting section 25 located on a front surface side of the first protrusion 17 (in the embodiment, a front surface side of the vehicle lamp 1), a fourth reflecting section 26 located on a back surface side of the second protrusion 18 (in the embodiment, a back surface side of the vehicle lamp 1), and a fourth emitting section 27 located on a front surface side of the second protrusion 18 (in the embodiment, a front surface side of the vehicle lamp 1).

The incidence section 19 is located on a base end (lower end) side of the first light guide part 11, and has a flat (planar) incidence surface 19a facing the light source 3. The incidence section 19 causes light L emitted from the light source 3 to enter the first light guide part 11 (the first inner lens 4) from the incidence surface 19a. In addition, the light L entering from the incidence section 19 is guided toward the diverging portion 12 on the tip (upper end) side of the first light guide part 11 through the first light guide part 11.

Further, the incidence section 19 is not limited to the configuration having the flat (planar) incidence surface 19a described above, but may be configured to have a lens shape that collimates or focuses the light L radially emitted from the light source 3 and causes the light L to enter the inside of the first light guide part 11.

The diverging portion 12 is located on the tip (upper end) side of the first light guide part 11, and is a portion where the first curved portion 15 of the second light guide part 13 and the second curved portion 16 of the third light guide part 14 diverge while curving in opposite directions, and guides the light L guided toward the tip side of the first light guide part 11 while diverging the light L between the side of the second light guide part 13 and the side of the third light guide part 14.

In addition, in the light L guided from the incidence section 19 toward the diverging portion 12, light L1 diverged from the diverging portion 12 toward the second light guide part 13 is guided from the base end side toward the tip side of the second light guide part 13 via the first curved portion 15. Meanwhile, among the light L guided from the incidence section 19 toward the diverging portion 12, light L2 diverged from the diverging portion 12 toward the third light guide part 14 is guided from the base end side toward the tip side of the third light guide part 14.

Further, some light L3 among the light L1 diverged toward the second light guide part 13 is guided from the first curved portion 15 toward the first protrusion 17. Meanwhile, some light L4 in the light L2 diverged toward the third light guide part 14 is guided from the second curved portion 16 toward the second protrusion 18.

Incidentally, in the first inner lens 4, lengths of the second light guide part 13 and the third light guide part 14 are different, and the second light guide part 13 extending toward one side in a first direction (in the embodiment, the vehicle width direction of the vehicle lamp 1) is longer than the third light guide part 14 extending toward the other side in the first direction.

On the other hand, in the diverging portion 12, a proportion of the light L1 guided toward the second light guide part 13 and a proportion of the light L2 guided toward the third light guide part 14 are adjusted according to a difference in length (optical path length) between the second light guide part 13 and the third light guide part 14.

Specifically, in the diverging portion 12, since the second light guide part 13 is longer than the third light guide part 14, with respect to a boundary line BX passing through a boundary 12a between the second light guide part 13 and the third light guide part 14, an optical axis AX of the light L emitted from the light source 3 is arranged so as to be shifted toward the second light guide part 13.

Accordingly, among the light L guided toward the diverging portion 12, a proportion of the light L1 diverged and guided toward the second light guide part 13 is adjusted to be greater than a proportion of the light L2 diverged and guided toward the third light guide part 14.

The plurality of first reflecting sections 20 are arranged side by side at intervals in the direction in which the second light guide part 13 extends (leftward/rightward direction) on the back surface side of the second light guide part 13. In addition, each of the first reflecting sections 20 has a plurality of reflection cuts 20a arranged in a direction in which the second light guide part 13 extends (leftward/rightward direction).

As long as the plurality of reflection cuts 20a reflects the light L1 entering the back surface side of the second light guide part 13 at an angle in which the light L1 is emitted (transmitted) to the outside from the front surface side of the second light guide part 13, and there are no particular limitations on their shapes, sizes, numbers, or the like. In the embodiment, as the plurality of reflection cuts 20a, groove portions having approximately triangular cross sections, which are formed by cutting out the back surface side of the second light guide part 13 in the upward/downward direction, are arranged side by side in the leftward/rightward direction.

In addition, in order for the plurality of reflection cuts 20a to uniformly distribute the light L1 emitted from each of the first emitting sections 21 in the direction in which the second light guide part 13 extends (leftward/rightward direction), the depth of the groove portion forming the reflection cuts 20a gradually increases from the base end side towards the tip side of the second light guide part 13. Alternatively, the intervals between adjacent ones of the plurality of reflection cuts 20a may become gradually shorter from the base end side towards the tip side of the second light guide part 13.

The first emitting section 21 is located on a front surface side of the second light guide part 13, and has a first emitting surface 21a continuous in the direction in which the second light guide part 13 extends (leftward/rightward direction). The first emitting surface 21a is constituted by a convex surface curved in an arc shape in a cross section (vertical cross section) in a direction perpendicular to the extension direction of the second light guide part 13.

In the first emitting section 21, the light L1 reflected by the plurality of reflection cuts 20a (the first reflecting section 20) is emitted from the first emitting surface 21a to the outside of the second light guide part 13.

The plurality of second reflecting sections 22 are provided on the back surface side of the third light guide part 14 side by side at intervals in the direction in which the third light guide part 14 extends (leftward/rightward direction). In addition, the plurality of reflection cuts 22a are arranged on each of the second reflecting sections 22 in the direction in which the third light guide part 14 extends (leftward/rightward direction).

As long as the plurality of reflection cuts 22a reflects the light L2 entering the back surface side of the third light guide part 14 at an angle in which the light L2 is emitted (transmitted) to the outside from the front surface side of the third light guide part 14, and there are no particular limitations on their shapes, sizes, numbers, or the like. In the embodiment, as the plurality of reflection cuts 22a, groove portions having approximately triangular cross sections, which are formed by cutting out the back surface side of the third light guide part 14 in the upward/downward direction, are arranged side by side in the leftward/rightward direction.

In addition, in order for the plurality of reflection cuts 22a to uniformly distribute the light L2 emitted from each of the second emitting sections 23 in the direction in which the third light guide part 14 extends (leftward/rightward direction), the depth of the groove portion forming the reflection cuts 22a gradually increases from the base end side towards the tip side of the third light guide part 14. Alternatively, the intervals between adjacent ones of the plurality of reflection cuts 22a may become gradually shorter from the base end side towards the tip side of the third light guide part 14.

The second emitting section 23 is located on the front surface side of the third light guide part 14 and has a second emitting surface 23a continuous in the direction in which the third light guide part 14 extends (leftward/rightward direction). The second emitting surface 23a is constituted by a convex surface curved in an arc shape in a cross section (vertical cross section) in a direction perpendicular to the extension direction of the third light guide part 14.

In the second emitting section 23, the light L2 reflected by the plurality of reflection cuts 22a (the second reflecting section 22) is emitted to the outside of the third light guide part 14 from the second emitting surface 23a.

The third reflecting section 24 is located on the back surface side of the first protrusion 17 inclined toward the front surface side of the first protrusion 17, and has a plurality of reflection cuts 24a arranged in a direction in which the first protrusion 17 protrudes (upward/downward direction).

As long as the plurality of reflection cuts 24a reflects the light L3 entering the back surface side of the first protrusion 17 at an angle in which the light L3 is emitted (transmitted) to the outside from the front surface side of the first protrusion 17, and there are no particular limitations on their shapes, sizes, numbers, or the like. In the embodiment, as the plurality of reflection cuts 24a, groove portions having substantially triangular cross sections, which are formed by cutting out the back surface side of the first protrusion 17 in the leftward/rightward direction, are arranged in the upward/downward direction.

In addition, in order for the plurality of reflection cuts 24a to uniformly distribute the light L3 emitted from the first protrusion 17 in the direction in which the first protrusion 17 protrudes (upward/downward direction), the depth of the groove portion forming the reflection cuts 24a gradually increases from the base end side to the tip side of the first protrusion 17. Alternatively, the intervals between adjacent ones of the plurality of reflection cuts 24a may become gradually narrower from the base end side to the tip side of the first protrusion 17.

The third emitting section 25 is located on the front surface side of the first protrusion 17 and has a flat (planar) third emitting surface 25a facing the third reflecting section 24. In the third emitting section 25, the light L3 reflected by the plurality of reflection cuts 24a (the third reflecting section 24) is emitted to the outside of the first protrusion 17 from the third emitting surface 25a.

The fourth reflecting section 26 is located on the back surface side of the second protrusion 18 inclined toward the front surface side of the second protrusion 18, and has a plurality of reflection cuts 26a arranged in the direction in which the second protrusion 18 protrudes (upward/downward direction).

As long as the plurality of reflection cuts 26a reflects the light L4 entering the back surface side of the second protrusion 18 at an angle in which the light L4 is emitted (transmitted) to the outside from the front surface side of the second protrusion 18, and there are no particular limitations on their shapes, sizes, numbers, or the like. In the embodiment, as the plurality of reflection cuts 26a, groove portions having substantially triangular cross section, which are formed by cutting out the back surface side of the second protrusion 18 in the leftward/rightward direction, are arranged in the upward/downward direction.

In addition, in order for the plurality of reflection cuts 26a to uniformly distribute the light LA emitted from the second protrusion 18 in the direction in which the second protrusion 18 protrudes (upward/downward direction), the depth of the groove portion forming the reflection cut 26a gradually increases from the base end side towards the tip side of the second protrusion 18. Alternatively, the intervals between adjacent ones of the plurality of reflection cuts 26a may become gradually shorter from the base end side to the tip side of the second protrusion 18.

The fourth emitting section 27 is located on the front surface side of the second protrusion 18 and has a flat (planar) fourth emitting surface 27a facing the fourth reflecting section 26. In the fourth emitting section 27, the light L4 reflected by the plurality of reflection cuts 26a (the fourth reflecting section 26) is emitted to the outside of the second protrusion 18 from the fourth emitting surface 27a.

The reflector 5 is constituted by a reflecting member such as a convex resin or the like, and disposed to surround the first inner lens 4 except the front surface side of the first inner lens 4 while opening the front surface side.

The reflector 5 has a reflecting surface 5a on its inside, and reflects the lights L1 to L4 emitted from the first inner lens 4 to the outside by the reflecting surface 5a, and emits the lights L1 to L4 toward the front surface side of the first inner lens 4.

The second inner lens 6 is constituted by a light guide body made of, for example, a transparent resin such as polycarbonate or acryl, or glass, has an elongated shape extending in the vehicle width direction, and is disposed so as to cover the front surface side of the first inner lens 4.

The second inner lens 6 has a flat (planar) incidence surface 6a on the back surface side, a plurality of protrusions 6b protruding forward from positions facing the first to fourth reflecting sections 20, 22, 24 and 26, respectively, on the front surface side, and a plurality of flat (planar) emitting surfaces 6c on tips of the plurality of protrusions 6b, respectively.

The plurality of protrusions 6b are arranged at equal intervals in the vehicle width direction (leftward/rightward direction) to correspond to the first to fourth reflecting sections 20, 22, 24 and 26, respectively. The plurality of emitting surfaces 6c are formed in a substantially rectangular shape at the tip of each of the protrusions 6b.

In the second inner lens 6, the lights L1 to L4 emitted from the first to fourth emitting sections 21, 23, 25 and 27 enter the inside from the incidence surface 6a. In addition, the lights L1 to L4 entering the incidence surface 6a are guided inside the plurality of protrusions 6b toward the tip, and are emitted to the outside from each of the emitting surfaces 6c.

The extension 7 is constituted by a colored (for example, black) shading member configured to cover the front surface side of the second inner lens 6, and has a plurality of opening portions 7a corresponding to the plurality of protrusions 6b, respectively. The extension 7 blocks the lights L1 to L4 emitted from the parts other than the emitting surfaces 6c of the second inner lens 6 by disposing the protrusions 6b inside the opening portions 7a so that the emitting surfaces 6c face the outside through the opening portions 7a.

In the vehicle lamp 1 having the above-mentioned configuration, it is possible to emit red light as the emitting surface of the lid lamp at the position corresponding to the plurality of emitting surfaces 6c arranged in the vehicle width direction.

Incidentally, in the vehicle lamp 1 of the embodiment, in order to cause the plurality of emitting surfaces 6c arranged in the vehicle width direction described above to emit light approximately uniformly (evenly), it is necessary to divide (distribute) the light L emitted from the light source 3 in an appropriate proportion depending on the lengths of the second light guide part 13 and the third light guide part 14 with respect to the diverging portion 12.

Specifically, in the embodiment, the second light guide part 13 is longer than the third light guide part 14 with respect to the diverging portion 12. For this reason, the optical axis AX of the light L emitted from the light source 3 is disposed to be shifted on the side of the second light guide part 13 with respect to the boundary line BX passing through the boundary 12a of the diverging portion 12. Accordingly, a larger amount of light quantity is divided on the side of the second light guide part 13 than the side of the third light guide part 14 with respect to the diverging portion 12.

In addition, in the embodiment, the light quantity is adjusted by the plurality of reflection cuts 20a and 22a such that the light quantity of the light L1 divided to each of the first emitting sections 21 provided in the second light guide part 13 is equal to the light quantity of the light L2 divided to each of the second emitting sections 23 provided in the third light guide part 14. Accordingly, it is possible to substantially uniformly (evenly) emit light from the emitting surfaces 6c corresponding to the first emitting section 21 and the second emitting section 23.

Meanwhile, when the optical axis AX of the light L emitted from the light source 3 is disposed to be shifted with respect to the boundary line BX of the boundary 12a of the diverging portion 12, as shown in FIG. 9, a difference occurs in the proportion of the lights L1 and L2 diverged to the side of the second light guide part 13 and the side of the third light guide part 14 via the diverging portion 12.

On the other hand, in the vehicle lamp 1 of the embodiment, as shown in FIG. 10, FIG. 11 and FIG. 12, according to the proportion of the lights L1 and L2 diverged to the side of the second light guide part 13 and the side of the third light guide part 14 via the diverging portion 12, a position of a first connecting portion 30a, to which the first protrusion 17 and the first curved portion 15 are connected, is different from a position of a second connecting portion 30b, to which the second protrusion 18 and the second curved portion 16 are connected, in a second direction which is perpendicular to at least the first direction (in the embodiment, the forward/rearward direction of the vehicle lamp 1).

Specifically, as the proportion of the lights L1 and L2 diverged via the diverging portion 12 is relatively increased, the first connecting portion 30a and the second connecting portion 30b are disposed closer to a center axis CX of the first curved portion 15 and the second curved portion 16 in the forward/rearward direction of the diverging portion 12.

Accordingly, it is possible to relatively increase the proportion of the light L3 guided from the first connecting portion 30a toward the first protrusion 17, or the proportion of the light L4 guided from the second connecting portion 30b toward the second protrusion 18.

Meanwhile, as the proportion of the lights L1 and L2 diverged via the diverging portion 12 is relatively increased, the first connecting portion 30a and the second connecting portion 30b are disposed to be more shifted from the center axis CX of the first curved portion 15 and the second curved portion 16 in the forward/rearward direction of the diverging portion 12.

Accordingly, it is possible to relatively reduce the proportion of the light L3 guided from the first connecting portion 30a toward the first protrusion 17, or the proportion of the light L4 guided from the second connecting portion 30b toward the second protrusion 18.

In the embodiment, as shown in FIG. 10, FIG. 11 and FIG. 12, in the forward/rearward direction of the diverging portion 12, the first protrusion 17 (the first connecting portion 30a) is disposed to be shifted to the front surface side from the center axis CX of the second curved portion 16, and the second protrusion 18 (the second connecting portion 30b) is disposed to approach the center axis CX of the second curved portion 16.

Accordingly, even when a difference occurs in the proportion of the lights L1 and L2 diverged to the side of the second light guide part 13 and the side of the third light guide part 14 via the diverging portion 12, it is possible to equalize the proportion of the light L3 guided from the first connecting portion 30a toward the first protrusion 17 and the light LA guided from the second connecting portion 30b toward the second protrusion 18.

Accordingly, in the vehicle lamp 1 of the embodiment, since the proportion of the light L3 emitted from the third emitting section 25 of the first protrusion 17 and the proportion of the light L4 emitted from the fourth emitting section 27 of the second protrusion 18 is equal, it is possible to cause the emitting surfaces 6c corresponding to the first protrusion 17 (the third emitting section 25) and the second protrusion 18 (the fourth emitting section 27) to emit light approximately uniformly (evenly) together with the emitting surfaces 6c corresponding to the other emitting sections (the first emitting section 21 and the second emitting section 23).

In addition, in the vehicle lamp 1 of the embodiment, as shown in FIG. 11 and FIG. 12, according to the ratio of the lights L1 and L2 diverged to the side of the second light guide part 13 and the side of the third light guide part 14 via the diverging portion 12, cross-sectional areas S1 and S2 of the first connecting portion 30a and the second connecting portion 30b are different from each other.

Specifically, in the first connecting portion 30a and the second connecting portion 30b, as the proportion of the lights L1 and L2 diverged through the diverging portion 12 is relatively increased, the cross-sectional areas S1 and S2 become relatively smaller.

Accordingly, it is possible to relatively reduce the proportion of the light L3 guided from the first connecting portion 30a toward the first protrusion 17 or the proportion of the light L4 guided from the second connecting portion 30b toward the second protrusion 18.

Meanwhile, as the proportion of the lights L1 and L2 diverged to the side of the second light guide part 13 and the side of the third light guide part 14 via the diverging portion 12 gets relatively smaller, the cross-sectional areas S1 and S2 gets relatively larger.

Accordingly, it is possible to relatively increase the proportion of the light L3 guided from the first connecting portion 30a toward the first protrusion 17 or the proportion of the light L4 guided from the second connecting portion 30b toward the second protrusion 18.

In the embodiment, as shown in FIG. 11 and FIG. 12, since the thickness of the first protrusion 17 is smaller than the thickness of the second protrusion 18, the cross-sectional area S1 of the first connecting portion 30a is smaller than the cross-sectional area S2 of the second connecting portion 30b.

Accordingly, even when a difference occurs in the proportion of the lights L1 and L2 diverged to the side of the second light guide part 13 and the side of the third light guide part 14 via the diverging portion 12, it is possible to equalize the proportion of the light L3 guided from the first connecting portion 30a toward the first protrusion 17 and the proportion of the light LA guided from the second connecting portion 30b toward the second protrusion 18.

Accordingly, the vehicle lamp 1 of the embodiment, since the proportion of the light L3 emitted from the third emitting section 25 of the first protrusion 17 and the proportion of the light L4 emitted from the fourth emitting section 27 of the second protrusion 18 is equalized, it is possible to cause the emitting surfaces 6c corresponding to the first protrusion 17 (the third emitting section 25) and the second protrusion 18 (the fourth emitting section 27) to substantially uniformly (evenly) emit light together with the emitting surfaces 6c corresponding to the other emitting sections (the first emitting section 21 and the second emitting section 23).

As described above, in the vehicle lamp 1 of the embodiment, the light L emitted from the light source 3 can be substantially uniformly divided (distributed) with respect to the plurality of emitting surfaces 6c arranged in the vehicle width direction, and the plurality of emitting surfaces 6c can emit light with uniform illuminance (brightness).

Accordingly, in the vehicle lamp 1 of the embodiment, it is possible to improve appearance upon emission while preventing occurrence of the brightness unevenness.

Further, the present invention is not particularly limited to the embodiment, and various modifications may be made without departing from the scope of the present invention.

For example, in the embodiment, while the case in which the vehicle lamp 1 is applied to the lid lamp has been exemplified, with regard to the vehicle lamp to which the present invention is applied, the present invention can be applied to not only the rear-side vehicle lamps as described above, but also front-side vehicle lamps.

That is, with regard to the vehicle lamps to which the present invention is applied, in addition to the lid lamp described above, the present invention can be widely applied to vehicle lamps such as, for example, tail lamps, stop lamps, back lamps, daytime running lamps (DRLs), sidelights (position lamps), direction indicators (turn lamps), and the like.

In addition, as for the light source, in addition to the above-mentioned LED, light emitting elements such as a laser diode (LD) or the like can be used. In addition, the color of the light emitted from the light source can be changed appropriately depending on the purpose of the vehicle lamp, such as white light, orange, or the like, in addition to the red light as mentioned above.

### REFERENCE SIGNS LIST

1 Vehicle lamp
2 Lighting body
3 Light source
4 First inner lens (light guide body)
5 Reflector
6 Second inner lens
7 Extension
8 Housing
9 Outer lens
10 Coupler socket
11 First light guide part
12 Diverging portion
13 Second light guide part
14 Third light guide part
15 First curved portion
16 Second curved portion
17 First protrusion
18 Second protrusion
19 Incidence section
20 First reflecting section
21 First emitting section
22 Second reflecting section
23 Second emitting section
24 Third reflecting section
25 Third emitting section
26 Fourth reflecting section
27 Fourth emitting section
30a First connecting portion
30b Second connecting portion
L, L1, L2, L3, L4 Light

1. A vehicle lamp comprising:
a light source; and
a light guide body configured to guide light emitted from the light source,
wherein the light guide body has:
a first light guide part disposed in front of the light source;
an incidence section that is located on a base end side of the first light guide part and that is configured to cause the light emitted from the light source to enter the first light guide part;
a diverging portion located on a tip side of the first light guide part;
a second light guide part extending from the diverging portion toward one side in a first direction;
a third light guide part extending from the diverging portion toward other side in the first direction;
a first curved portion that is a portion of the second light guide part curved from the diverging portion toward the one side in the first direction;
a second curved portion that is a portion of the third light guide part curved from the diverging portion toward the other side in the first direction;
a first protrusion protruding from the first curved portion toward a side opposite to the diverging portion; and
a second protrusion protruding from the second curved portion toward a side opposite to the diverging portion,
an optical axis of the light emitted from the light source is arranged to be shifted to the one side or the other side in the first direction with respect to a boundary of the diverging portion, and
according to a proportion of the light diverged to the side of the second light guide part and the side of the third light guide part via the diverging portion,
a position of a first connecting portion, at which the first protrusion and the first curved portion are connected, is different from a position of a second connecting portion, at which the second protrusion and the second curved portion are connected, in a second direction which is perpendicular to at least the first direction.

2. The vehicle lamp according to claim 1, wherein the first connecting portion and the second connecting portion are;
disposed closer to a center axis of the first curved portion and the second curved portion in the second direction as a proportion of the light diverged via the diverging portion gets relatively reduced, and
disposed to be more shifted from the center axis of the first curved portion and the second curved portion in the second direction as the proportion of the light diverged via the diverging portion gets relatively increased.

3. The vehicle lamp according to claim 1, wherein, according to the proportion of the light diverged to the side of the second light guide part and the side of the third light guide part via the diverging portion,
cross-sectional areas of the first connecting portion and the second connecting portion are different from each other.

4. The vehicle lamp according to claim 3, wherein the cross-sectional areas of the first connecting portion and the second connecting portion are relatively reduced as the proportion of the light diverged via the diverging portion is relatively increased, and
the cross-sectional areas of the first connecting portion and the second connecting portion are relatively increased as the proportion of the light diverged via the diverging portion is relatively reduced.

5. The vehicle lamp according to claim 1, wherein the light guide body has:
a first reflecting section that is located on a back surface side of the second light guide part and that is configured to reflect the light guided in the second light guide part toward a front surface side of the second light guide part;
a first emitting section that is located on a front surface side of the second light guide part and that is configured to emit the light reflected by the first reflecting section to an outside of the second light guide part;
a second reflecting section that is located on a back surface side of the third light guide part and that is configured to reflect the light guided in the third light guide part toward a front surface side of the third light guide part;
a second emitting section that is located on a front surface side of the third light guide part and that is configured to emit the light reflected by the second reflecting section to an outside of the third light guide part;
a third reflecting section that is located on a back surface side of the first protrusion and that is configured to reflect the light guided in the first protrusion toward a front surface side of the first protrusion;
a third emitting section that is located on a front surface side of the first protrusion and that is configured to emit the light reflected by the third reflecting section to an outside of the first protrusion;
a fourth reflecting section that is located on a back surface side of the second protrusion and that is configured to reflect the light guided in the second protrusion toward a front surface side of the second protrusion; and
a fourth emitting section that is located on a front surface side of the second protrusion and that is configured to emit the light reflected by the fourth reflecting section to an outside of the second protrusion.
